(19) United States
(12) Patent Application Publication
(10) Pub. No.: US 2023/0188181 A1
(43) Pub. Date: Jun. 15, 2023

(54) BASE STATION ANTENNA

(71) Applicant: CommScope Technologies LLC, Hickory, NC (US)

(72) Inventor: Ligang WU, Suzhou, Jiangsu (CN)

(21) Appl. No.: 17/998,899

(22) PCT Filed: May 17, 2021
(86) PCT No.: PCT/US2021/032724

§ 371 Date: Nov. 15, 2022

(30) Foreign Application Priority Data
Jun. 24, 2020 (CN) 202010587214.9

(51) Int. Cl. H04B 7/0408; H04B 7/06; H01Q 1/24; H01Q 3/36; H01Q 3/40

(52) U.S. Cl. CPC H04B 7/0408; H04B 7/0682; H04B 7/0617; H01Q 1/246; H01Q 3/36; H01Q 3/40

(57) ABSTRACT

Base station antennas include an array of radiating elements that includes multiple columns of radiating elements, with each column including multiple radiating elements, a first phase shifter configured to change a phase of a radio frequency (RF) signal of a first frequency band for transmission in a beam forming mode, a second phase shifter configured to change a phase of an RF signal of a second frequency band for transmission in a multi-beam mode, where the RF signal of the second frequency band includes first and second beam signals, a multi-beam device configured to generate an output signal according to the phase shifted first beam signal and the phase shifted second beam signal, and a diplexer configured to receive the phase shifted RF signal of the first frequency band and the output signal of the multi-beam device, and transmit an output signal to the corresponding radiating elements.

### CROSS-REFERENCE TO RELATED APPLICATION

The present application claims priority to Chinese Patent Application No. 202010587214.9, filed Jun. 24, 2020, the entire content of which is incorporated herein by reference as if set forth fully herein.

### FIELD

The present disclosure relates to a base station antenna.

### BACKGROUND

Cellular communications systems are well known in the art. In a typical cellular communication system, a geographic area is divided into a series of areas called “cells”, and each cell is served by a base station. The base station may include a base station antenna, a baseband device, and a radio configured to provide bidirectional radio frequency (“RF”) communication with subscribers located throughout the cell. In many cases, the cells can be divided into multiple “sectors”, and different base station antennas provide coverage for each sector. Base station antennas are usually mounted on towers or other raised structures, and the radiation beam (“antenna beam”) generated by each antenna points outward to serve a corresponding sector. Base station antennas typically include multiple arrays of radiating elements. Each array of radiating elements may generate one or more antenna beams that support service in various different frequency bands.

### SUMMARY

In one aspect of the present disclosure, there is provided a base station antenna including: an array of radiating elements, including multiple columns of radiating elements with each column including multiple radiating elements; a first phase shifter configured to change a phase of a radio frequency (RF) signal of a first frequency band for transmission in a beam forming mode; a second phase shifter configured to change a phase of an RF signal of a second frequency band for transmission in a multi-beam mode, wherein the second frequency band is different from the first frequency band, the RF signal of the second frequency band includes a first beam signal and a second beam signal; a multi-beam device configured to generate an output signal corresponding to the corresponding radiating elements according to the phase shifted first beam signal and the phase shifted second beam signal; and a diplexer configured to receive the phase shifted RF signal of the first frequency band and the output signal of the multi-beam device, and transmit a diplexer output signal to the corresponding radiating elements.

In some embodiments of the present disclosure, the second phase shifter comprises a first beam phase shifter configured to change a phase of the first beam signal; and a second beam phase shifter configured to change a phase of the second beam signal.

In some embodiments of the present disclosure, a predetermined amount of radiating elements in each row are coupled to the same diplexer, the base station antenna further comprises: a power divider configured to distribute a power of the corresponding diplexer output signal to a predetermined amount of corresponding radiating elements according to a predetermined ratio.

In some embodiments of the present disclosure, the predetermined amount is greater than or equal to 2 and less than or equal to 6.

In some embodiments of the present disclosure, the multi-beam device is a Butler matrix.

In some embodiments of the present disclosure, the Butler matrix includes a first input port, a second input port and a plurality of first output ports, the first input port receives the phase shifted first beam signal, the second input port receives the phase shifted second beam signal, and the plurality of first output ports are respectively coupled to corresponding radiating elements through the plurality of diplexers.

In some embodiments of the present disclosure, the array of radiating elements comprises a plurality of rows, and the plurality of output ports of each Butler matrix are coupled to corresponding radiating elements in the same row.

In some embodiments of the present disclosure, the diplexer comprises a third input port, a fourth input port and a second output port, and the third input port receives the phase shifted RF signal of the first frequency band, the fourth input port is coupled to the first output port of the Butler matrix, and the second output port is coupled to the corresponding radiating element.

In some embodiments of the present disclosure, the first phase shifter comprises a plurality of third output ports which are respectively coupled to corresponding radiating elements in the same column.

In another aspect of the present disclosure, there is provided a base station antenna including: an array of radiating elements, including multiple columns of radiating elements with each column including multiple radiating elements; a multi-beam device configured to generate an output signal corresponding to the radiating elements according to a first beam signal and a second beam signal in a radio frequency (RF) signal of the second frequency band for transmission in a multi-beam mode; a plurality of diplexers configured to receive an RF signal of the first frequency band for transmission in a beam-forming mode and the output signal of the multi beam device, and output a diplexer output signal; and a phase shifter configured to change the phases of the diplexer output signal and output the phase shifted mixed signal to corresponding radiating elements.

In some embodiments of the present disclosure, the multi-beam device is a Butler matrix.

In some embodiments of the present disclosure, the Butler matrix includes a first input port, a second input port and a plurality of first output ports, the first input port receives the first beam signal, the second input port receives the second beam signal, and the plurality of first output ports are respectively coupled to the corresponding radiating elements through the plurality of diplexers.

In some embodiments of the present disclosure, the array of radiating elements comprises a plurality of rows, and the plurality of output ports of the Butler matrix are coupled to corresponding radiating elements in the same row.

In some embodiments of the present disclosure, the diplexer comprises a third input port, a fourth input port and a second output port, the third input port receives the RF signal of the first frequency band, the fourth input port is coupled to the first output port of the Butler matrix, and the second output port is coupled to the corresponding radiating element.

In some embodiments of the present disclosure, the first phase shifter comprises a plurality of third output ports which are respectively coupled to corresponding radiating elements in the same column of the array of radiating elements.

In a further aspect of the present disclosure, there is provided a base station antenna comprising: a first sector-splitting port; a second sector-splitting port; a plurality of beam forming ports; a multi-column array of radiating elements, with each column including multiple radiating elements; a plurality of first phase shifters that are coupled between the respective beam forming ports and the columns of the array of radiating elements, the plurality of first phase shifters together having a plurality of first phase shifter outputs; a second phase shifter having an input port that is coupled to the first sector-splitting port and a plurality of second phase shifter outputs; a third phase shifter having an input port that is coupled to the second sector-splitting port and a plurality of third phase shifter outputs; a plurality of multi-beam devices, each multi-beam device coupled to a respective one of the second phase shifter outputs and a respective one of the third phase shifter outputs, the plurality of multi-beam devices together having a plurality of multi-beam device outputs; and a plurality of diplexers, each diplexer having a first input port that is coupled to a respective one of the first phase shifter outputs, a second input port that is coupled to a respective one of the multi-beam device outputs, and an output port that is coupled to a respective one of the radiating elements in the array of radiating elements.

In some embodiments of the present disclosure, the multi-beam devices are Butler Matrices.

In some embodiments of the present disclosure, two first phase shifters are coupled to the radiating elements in each column of the array of radiating elements for each polarization radiator of the radiating elements.

In some embodiments of the present disclosure, the number of Butler Matrices that are connected to the multi-column array of radiating elements is equal to twice the number of columns in the multi-column array of radiating elements.

In some embodiments of the present disclosure, a predetermined amount of radiating elements in each row are coupled to the same diplexer, the base station antenna further comprises a power divider configured to distribute a power of the signal output from the output port of the corresponding diplexer to a predetermined amount of corresponding radiating elements according to a predetermined ratio.

In some embodiments of the present disclosure, the predetermined amount is greater than or equal to 2 and less than or equal to 6.

In some embodiments of the present disclosure, the array of radiating elements comprises a plurality of rows, and the plurality of multi-beam device outputs of each multi-beam devices are coupled to corresponding radiating elements in the same row.

In a still further aspect of the present disclosure, there is provided a base station antenna comprising: a first sector-splitting port; a second sector-splitting port; a plurality of beam forming ports; a multi-beam device having first and second inputs that are coupled to the respective first and second sector-splitting ports and a plurality of multi-beam device outputs; a plurality of phase shifters, the plurality of phase shifters together having a plurality of phase shifter outputs; a plurality of diplexers, each diplexer having a first input port that is coupled to a respective one of the beam forming ports, a second input port that is coupled to a respective one of the multi-beam device outputs, and an output port that is coupled to a respective one of the phase shifters; a multi-column array of radiating elements, with each column including multiple radiating elements; wherein each phase shifter output is coupled to a respective one of the radiating elements in the array of radiating elements.

In some embodiments of the present disclosure, the multi-beam device is a Butler Matrix.

In some embodiments of the present disclosure, the array of radiating elements comprises a plurality of rows, and the plurality of multi-beam device outputs of each multi-beam devices are coupled to corresponding radiating elements in the same row of the array of radiating elements.

In some embodiments of the present disclosure, each of the phase shifters includes a plurality of phase shifter outputs, and the plurality of the phase shifter outputs of each phase shifter are respectively coupled to the corresponding radiating elements in the same column of the array of radiating elements.

In a still further aspect of the present disclosure, there is provided a base station including the base station antenna of the present disclosure.

Other features and advantages of the present disclosure will become clearer from the following detailed description of exemplary embodiments of the present disclosure with reference to the drawings.

### BRIEF DESCRIPTION OF THE DRAWING

FIG. 1 is a schematic diagram of a base station antenna according to an embodiment of the present disclosure.

FIG. 2 is a schematic diagram of a base station antenna according to another embodiment of the present disclosure.

FIG. 3 is a schematic diagram of a base station antenna according to a still further embodiment of the present disclosure.

Note that, in the embodiments described below, the same reference numbers are commonly used between different drawings to indicate the same components or components having the similar function, and repeated description thereof is omitted. In some cases, similar reference numbers and letters are used to denote similar items, so once an item is defined in one drawing, there is no need to discuss it further in subsequent drawings.

For ease of understanding, the position, size, and range of each structure shown in the drawings and the like may not indicate the actual position, size, and range. Therefore, the present disclosure is not limited to the positions, sizes, ranges, etc. disclosed in the drawings and the like.

### DETAILED DESCRIPTION

Various exemplary embodiments of the present disclosure will be described in detail below with reference to the drawings. It should be noted that the relative arrangement of components and steps, numerical expressions, and numerical values set forth in these embodiments do not limit the scope of the present disclosure unless specifically stated otherwise.

The following description of at least one exemplary embodiment is actually merely illustrative, and in no way serves as any limitation to the present disclosure and its application or use. That is, the structures and methods herein are shown in an exemplary manner to illustrate different embodiments of the structures and methods in the present disclosure. However, those skilled in the art will understand that they only illustrate exemplary ways of implementing the present disclosure, not exhaustively. In addition, the drawings are not necessarily drawn to scale, and some features may be exaggerated to show details of specific components.

Techniques, methods and equipment known to those of ordinary skill in the related art may not be discussed in detail, but where appropriate, the techniques, methods and equipment should be considered as part of the specification.

In all examples shown and discussed herein, any specific value should be interpreted as merely exemplary and not limiting. Therefore, other examples of the exemplary embodiment may have different values.

In order to increase capacity, some wireless operators are requesting base station antennas that include both a first “beam-forming” array of radiating elements that allows for actively changing the shape of the antenna beam and a second “multi-beam” array of radiating elements that generates multiple (e.g. two) static antenna beams that can be used to split a sector into two or more sub-sectors. For example, wireless operators have requested base station antennas that include both a beam-forming array that operates in the 2.6 GHz frequency band and a multi-beam (typically a dual or “twin” beam) array that operates in the 1.8 GHz frequency band. Conventional base station antennas including such functionality mount the two arrays in side-by-side fashion or stack the two arrays in the vertical direction. However, as both arrays are large (e.g., each array may have four columns of radiating elements), the resultant base station antenna may be quite large. For example, antenna arrays arranged side-by-side in the horizontal direction will increase the width of the antenna, and antenna arrays stacked in the vertical direction will increase the length of the antenna. The “vertical direction” here refers to the direction roughly perpendicular to the horizontal plane. Wireless operators would prefer smaller base station antennas that require less space for mounting on a tower and which are subject to lower wind loading levels.

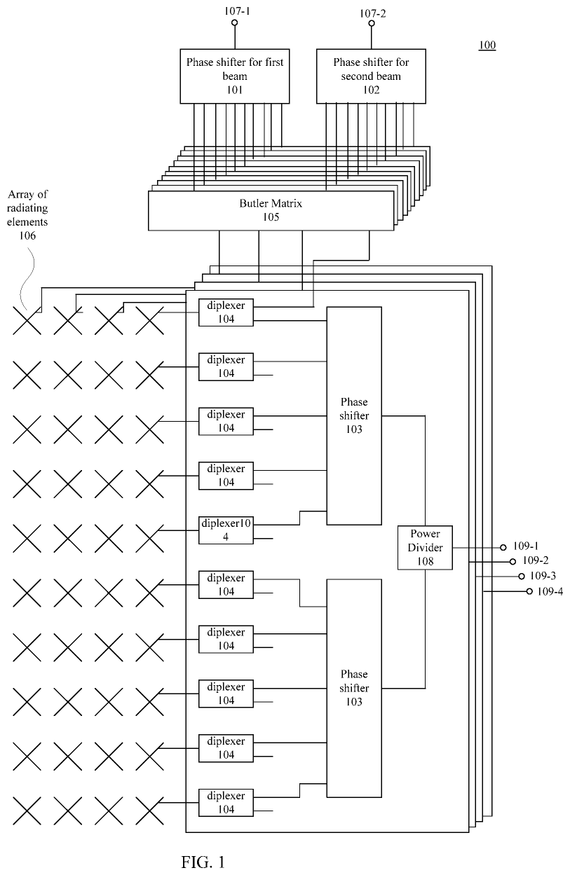

FIG. 1 is a schematic diagram of a base station antenna according to an embodiment of the present disclosure that includes a single array of dual-polarized radiating elements 106. As is well known in the art, dual-polarized radiating elements refer to radiating elements that have first and second radiators that transmit and receive RF signals at orthogonal polarizations, which allows the base station antenna to generate twice as many antenna beams without increasing the size of the array of radiating elements. While the base station antenna of FIG. 1 includes dual-polarized radiating elements, FIG. 1 only shows the feed networks for one of the two polarizations. It will be appreciated that the feed networks shown in FIG. 1 will be duplicated for the second polarization.

As shown in FIG. 1, the base station antenna 100 includes two ports 107 (per polarization) for the twin beam portion of the antenna and four ports 109 (per polarization) for the beam-forming portion of the antenna. Ports 107-1 and 107-2 may be connected to a radio (or radios) that provide the RF signals that are used to generate the two static sector-splitting beams, while ports 109-1 through 109-4 may be connected to respective ports on a beam-forming radio. The feed network for the twin beam portion of the antenna includes the ports 107, a phase shifter 101 for the first beam, a phase shifter 102 for the second beam, and a Butler Matrix 105. The feed network for the beam-forming portion of the antenna includes the ports 109, a power divider 108, and first phase shifters 103. A plurality of diplexers 104 are provided that connect the two feed networks to the array of radiating elements 106.

The radiating elements in the array of radiating elements 106 are arranged in rows and columns. In the embodiment of FIG. 1, the array of radiating elements 106 includes forty dual-polarized radiating elements that are arranged in four columns and ten rows. As noted above, the array of radiating elements 106 is shown as including dual-polarized radiating elements where each radiating element includes a first radiator that transmits and receives RF radiation having a slant −45° polarization and a second radiator that transmits and receives RF radiation having a slant +45° polarization. The radiators are shown as being dipole radiators in FIG. 1. It should be understood that radiating elements having other types of radiators can be used as long as the radiating element is a broadband radiating element capable of radiating/receiving radio frequency (RF) signals in two different frequency bands (the first and second frequency bands).

The feed network for the beam-forming portion of the antenna is illustrated in the lower right portion of FIG. 1. As shown, port 109-1 feeds the first polarization radiators of each of the radiating elements in a first of the columns in the array of radiating elements 106. Port 109-1 may be connected to a first port of a beam-forming radio (not shown). The beam-forming radio may generate RF signals in a first frequency band that are to be transmitted through the array of radiating elements 106. RF signals input to port 109-1 pass to a power divider 108 that splits the RF signal into first and second sub-components that are input to respective first and second phase shifters 103. The phase shifters 103 further subdivide the respective first and second sub-components of the RF signal and adjust the relative phases of these sub-components to impart an electrical downtilt to the antenna beam formed by the first column of radiating elements in response to an RF signal input at port 109-1. The phase shifted sub-components of the RF signal output by the phase shifters 103 are passed to respective diplexers 104 that output the sub-components to the individual radiating elements in the first column of the array of radiating elements 106. In the exemplary embodiment shown in FIG. 1, each first phase shifter 103 includes five output ports, and each phase shifter output is coupled to a single radiating element. Accordingly, a total of two phase shifters 103 are provided per column (per polarization) to feed the ten radiating elements in the column.

Ports 109-2 through 109-4 similarly feed the remaining three columns of the array of radiating elements 106 through additional power dividers 108, phase shifters 103 and diplexers 104 that are not visible in FIG. 1. Thus, the feed network for the beam-forming portion of the antenna 100 includes a total of eight phase shifters 103 per polarization, or sixteen phase shifters 103 in total.

It should be understood that the number of output ports included on each of the phase shifters 103 is not limited to five, but may be any number, and those skilled in the art may choose as required. Moreover, the number of phase shifters 103 in the base station antenna depends on the number of radiating elements in the array of radiating elements 106 and the number of output ports included on each phase shifter 103. For example, when each phase shifter 103 has 10 output ports, a total of eight phase shifters 103 may be provided in the base station antenna 100 (and the power dividers 108 may be omitted).

Each diplexer 104 is a three port RF device. The diplexers 104 can have the frequency division function of a high pass filter, a low pass filter or a band-pass filter. Each diplexer 104 includes a first frequency band port that only passes RF signals in a first frequency band, a second frequency band port that only passes RF signals in a second frequency band, and a common port that passes RF signals in both the first frequency band and the second frequency band. The first frequency band port of each diplexer 104 is coupled to a respective output of one of the phase shifters 103, the second frequency band port is coupled to a respective output of a Butler Matrix 105 (described below), and the common port is coupled to a respective one of the radiating elements. Each diplexer 104 thus allows a respective one of the radiating elements to be fed by two different feed networks so that the radiating element can transmit and receive RF signals in two different frequency bands. In the embodiment shown in FIG. 1, each dipole radiator of each radiating element has a corresponding diplexer 104. Therefore, the base station antenna 100 includes a total of eighty diplexers 104. For simplicity, only a subset of the diplexers 104 are shown, and the other diplexers 104 have similar connections.

The feed network for the twin-beam portion of the antenna is illustrated in the top portion of FIG. 1. The feed network for the twin-beam portion is connected to one or more radios that generate the static twin beams. The static twin beams are generated by RF signals in a second frequency band. The second frequency band is different from the first frequency band. It should be understood that different countries and regions use different frequency bands for different types of wireless communication services. Therefore, some examples of the first and second frequency bands in the present disclosure are as follows:

The second frequency band: 1710-1880 MHz, the first frequency band: 2300-2400 MHz;

The second frequency band: 1850-1995 MHz, the first frequency band: 2496-2690 MHz;

The second frequency band: 1695-2180 MHz, the first frequency band: 2300-2690 MHz.

In the embodiment depicted in FIG. 1, the multi-beam portion of the antenna 100 is configured to generate a pair of antenna beams for each polarization (i.e., a total of four antenna beams). A first port of a radio is connected to the phase shifter for the first beam 101 and a second port of a radio (which may be the same radio or a different radio) is connected to the phase shifter for the second beam 102. The first beam phase shifter 101 may divide the RF signal output by the first radio port into a plurality of sub-components (ten sub-components in the example embodiment of FIG. 1), and may adjust the relative phases of the sub-components of the RF signal in order to apply an electrical downtilt to the first of the twin antenna beams. The second beam phase shifter 102 may divide the RF signal output by the second radio port into a plurality of sub-components (again ten sub-components in the example embodiment of FIG. 1), and may adjust the relative phases of the sub-components of the RF signal in order to apply an electrical downtilt to the second of the twin antenna beams.

The phase shifter for the first beam 101 and the phase shifter for the second beam 102 each have ten outputs in the depicted embodiment. A total of ten Butler Matrices 105 are also provided, with each Butler Matrix 105 connected to a respective one of the outputs of the phase shifter for the first beam 101 and a respective one of the outputs for the phase shifter for the second beam 102. Each Butler Matrix 105 includes four outputs, with each output connected to a respective one of the radiating elements in a row of radiating elements in array 106. For example, the four outputs of the first Butler Matrix 105 in FIG. 1 are respectively coupled to the first dipole radiator of the four radiating elements in the top row of array of radiating elements 106 through four diplexers 104 (only one of the four diplexers is visible in FIG. 1).

A Butler Matrix 105 is a known type of beam-forming network that is widely used in multi-beam antenna systems. A Butler Matrix may include various components such as a 3 dB branch line directional couplers, 45° phase shifter, 0 dB cross coupler, etc. A wide variety of Butler Matrix designs are known in the art. In an ideal situation, the Butler Matrix is a passive network. Each beam formed by the Butler Matrix can obtain the gain provided by the whole array of radiating elements 106, and the generated antenna beams point in different directions so that they are generally orthogonal. A Butler Matrix may be simple to produce and can be realized by transmission line structure with low cost. The present disclosure will not describe the internal structure of the Butler matrix in more detail.

The number of input ports for each Butler Matrix 105 is equal to the number of beams transmitted in the multi-beam mode. Since the multi-beam portion of antenna 100 of FIG. 1 is designed to produce a pair of static, sector-splitting antenna beams, each Butler Matrix 105 has two inputs, as shown in FIG. 1. Each Butler Matrix may be designed to include a number of output ports that corresponds to the number of columns of radiating elements included in the array of radiating elements 106.

In the embodiment shown in FIG. 1, the array of radiating elements 106 has four columns and ten rows, and each row of radiating elements requires two Butler Matrices 105 (namely one for each polarization). Therefore, there are 20 Butler Matrices 105 in the base station antenna 100. As discussed above, for simplicity, only one polarization is shown in FIG. 1, and the output ports of only one of the Butler Matrices 105 (and corresponding connections to the array 106 through the diplexers 104) is shown. The remaining Butler Matrices 105 have similar connections.

In addition, it should be understood that the Butler Matrix 105 is an example of a multi-beam device of the present disclosure. However, the multi-beam device is not limited to a Butler Matrix. Any device that can generate output signals corresponding to each radiating element according to the first beam signal and the second beam signal can be used as a multi-beam device. For example, in addition to the Butler Matrix 105, the multi-beam device may also be, for example, an RF remote unit (RRU), a 90° hybrid coupler, etc.

In addition, in the exemplary embodiment of FIG. 1, both the first beam phase shifter 101 and the second beam phase shifter 102 are phase shifters have ten output ports. The ten output ports of the first beam phase shifter 101 are respectively connected to the input ports of the corresponding ten Butler Matrices 105 for the first polarization. The ten output ports of the second beam phase shifter 102 are also connected to the corresponding ten input ports of the ten Butler Matrices for the first polarization. As described above, if each Butler Matrix 105 has four output ports, the base station antenna 100 has twenty Butler Matrices 105, and the base station antenna 100 has two first beam phase shifters 101 and two second beam phase shifters 102 (in each case one for each polarization). In other embodiments, first beam phase shifters 101 and second beam phase shifters 102 with different numbers of output ports may be used. For example, if each first beam phase shifter 101 and second beam phase shifter 102 only has five output ports, then the number of first beam phase shifters 101 and second beam phase shifters 102 will be doubled, and power dividers may be coupled between the input ports 107-1, 107-2 and the first beam phase shifters 101 and second beam phase shifters 102 in the same manner as shown for input port 109-1 and the two phase shifters 103. Thus, it will be understood that the number of output ports on each first beam phase shifter 101 and each second beam phase shifter 102 may be selected as any suitable number. Moreover, the number of first beam phase shifters and second beam phase shifters in the base station antenna depends on the number of radiating elements in the array of radiating elements 106, the number of output ports of the Butler Matrix and the number of output ports of each first beam phase shifter 101 and second beam phase shifter 102.

The base station antenna 100 shown in FIG. 1 can transmit RF signals in the first frequency band in a beam-forming manner and RF signals in the second frequency band in a multi-beam manner through a single array of radiating elements 106. Thus, the size of the base station antenna is reduced.

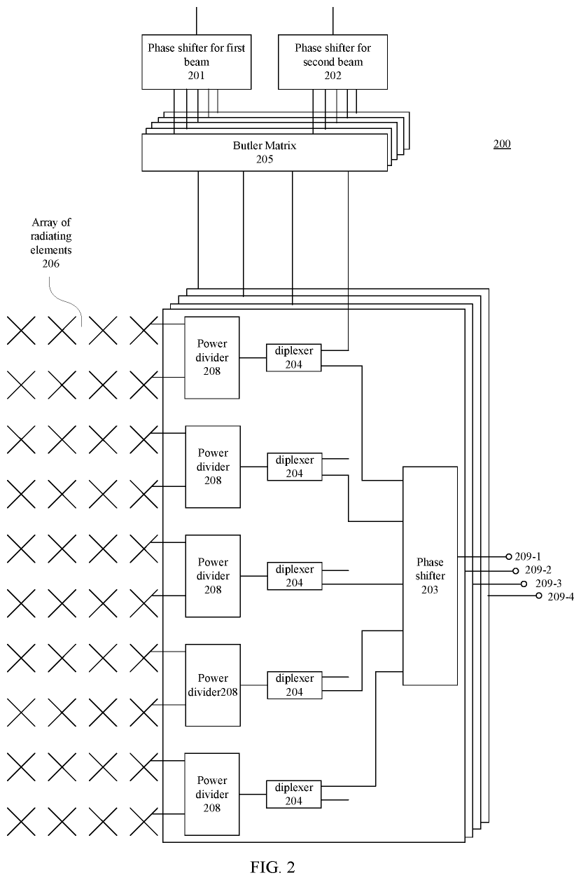

FIG. 2 is a schematic diagram of a base station antenna according to another embodiment of the present disclosure. As shown in FIG. 2, the base station antenna 200 includes a first beam phase shifter 201, a second beam phase shifter 202, a phase shifter 203, a plurality of diplexers 204, a plurality of Butler Matrices 205, and an array of radiating elements 206. The connections among these components are similar to that of the corresponding components in the base station antenna 100 of FIG. 1, and will not be repeated. The base station 200, however, includes a larger number of power dividers 208, and the power dividers 208 are interposed between the diplexers 204 and the array of radiating elements 206.

The array of radiating elements 206 is similar to the array of radiating elements 106 of the base station antenna 100 shown in FIG. 1, that is, the array of radiating elements 206 also includes four columns and ten rows of dual-polarized radiating elements. The primary difference between the antenna 100 of FIG. 1 and the antenna 200 of FIG. 2 is that the output of each diplexer 204 in antenna 200 is input to a power divider 208 that splits RF signals input thereto into two sub-components, and passes those sub-components to respective radiating elements. As shown in FIG. 2, in each column of radiating elements, two adjacent radiating elements are connected to the respective output ports of a power divider 208. By including the power dividers 208, the number of phase shifters 203 and the number of Butler Matrices 205 can be reduced. For example, compared with the base station antenna 100 shown in FIG. 1, the number of diplexers 204 is reduced from eighty to forty, the number of phase shifters 203 is reduced from sixteen to eight, the number of Butler Matrices 205 is reduced from twenty to ten. It will be appreciated that FIG. 2 again only shows the feed networks for one of the two polarizations.

It should be understood that the number of output ports of the power divider 208 is not limited to two, but may be any suitable amount. For example, in a case where the array of radiating elements contains nine columns and nine rows of radiating elements, each power divider 208 may include three output ports, each of which is connected to three adjacent radiating elements in the same column. Moreover, in some embodiments, not all of the power dividers 208 may have the same number of outputs.

In addition, for the sake of brevity, only a subset of the diplexers 204 and the power dividers 208 are shown in FIG. 2. As described above, in fact, the base station antenna 200 includes forty diplexers 204 and forty power dividers 208.

In addition, in the base station antenna 100 shown in FIG. 1 and base station antenna 200 shown in FIG. 2, the phase shifter(s) 103, 203 are used to adjust the phase of the sub-components of the RF signals in the first frequency band, and the first beam phase shifters 101, 201 and the second beam phase shifters 102, 202 are used to adjust the phase of the sub-components of the RF signals in the second frequency band. In this way, the electrical downtilt angles of the RF signals in the first frequency band and the second frequency band can be adjusted independently.

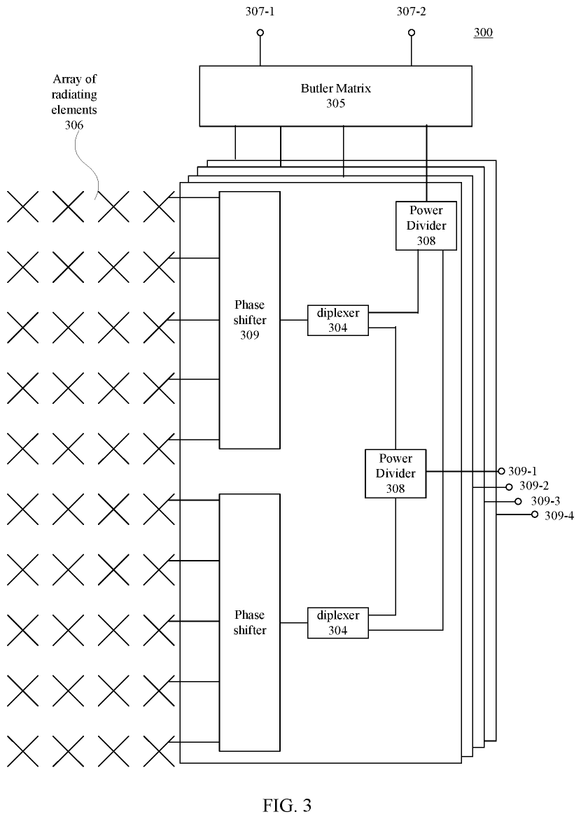

FIG. 3 is a schematic diagram of a base station antenna according to still further embodiments of the present disclosure. As shown in FIG. 3, the base station antenna 300 includes a plurality of phase shifters 309, a plurality of diplexers 304, a Butler Matrix 305, and an array of radiating elements 306.

The array of radiating elements 306 is similar to the array of radiating elements 106 in FIG. 1, and also includes four columns and ten rows of dual-polarized radiating elements.

The antenna 300 includes first and second ports 307-1, 307-2 (at each polarization) that may be connected to first and second ports of a radio (not shown). Ports 307-1 and 307-2 are respectively connected to two input ports of the Butler Matrix 305. The Butler Matrix 305 has four output ports can generate output signals corresponding to each radiating element according to the input first beam signal and the second beam signal. The output signal is output from the output port (first output port) of the Butler matrix 305 to a power divider 308. The power divider 308 splits the signal and provides the two sub-components thereof to respective first input ports of first and second diplexers 304.

In addition, the RF signal of the first frequency band to be transmitted in the beam-forming mode is split by another power divider 308, and the sub-components thereof are input to the respective second input ports of the first and second diplexers 304. The diplexers 304 may mix the RF signals of the first frequency band with the output signals from the Butler matrix 305, and output the mixed signal to the phase shifters 309.

The phase shifters 309 sub-divide the signals input thereto and then shift the phase of the sub-components to provide phase shifted mixed signals to the corresponding radiating elements.

It should be understood that for brevity, only a portion of the phase shifters 309 and their output ports are shown in FIG. 3. In a case where each phase shifter 309 has five output ports, each column of radiating elements corresponds to two phase shifters 309, and the base station antenna 300 is provided with a total of 16 phase shifters 309. Similarly, only a portion of diplexers 304 and Butler matrices 305 are shown in FIG. 3. The number of diplexers 304 is the same as the number of phase shifters 309. A total of two Butler matrices 305 are provided, one for each polarization.

In the base station antenna 300 of in FIG. 3, the phase shifters 309 are positioned between the diplexers 304 and the array of radiating elements 306. In this way, the phase shifters 309 can simultaneously change the phases of the sub-components of the RF signal of the first frequency band and the phases of the sub-components of the RF signal of the second frequency band, without providing different phase shifters for different frequency bands. The amount of phase shifters in the base station antenna is reduced.

The terms “before”, “after”, “top”, “bottom”, “above”, “below”, etc. in the specification and claims, if present, are for descriptive purpose and not necessarily used to describe an unchanged relative position. It will be understood that the terms are interchangeable in appropriate situations. The embodiments of the present disclosure described herein are, for example, capable of operating in orientation other than those shown or described herein.

As used in the present disclosure, the term “exemplary” means “serving as an example, instance, or illustration” rather than as a “model” to be precisely copied. Any embodiments exemplarily described herein are not necessarily to be construed as preferred or advantageous over other embodiments. Furthermore, the present disclosure is not limited by any of the stated or implied theory presented in the above technical field, the background, the summary or the detailed description of the embodiments.

As used herein, the term “substantially” is intended to include any minor variation resulting from a design or manufacturing defect, a device or component tolerance, environmental influence, and/or other factors. The term “substantially” also allows for deviation from perfect or ideal situations caused by parasitic effects, noise, and other practical considerations that may exist in actual implementations.

In addition, the foregoing description may refer to elements or nodes or features that are “connected” or “coupled” together. As used herein, “connect” means that an element/node/feature is directly connected electrically, mechanically, logically, or otherwise to (or directly communicate with) another element/node/feature, unless otherwise explicitly stated. Similarly, “couple” means that an element/node/feature may be mechanically, electrically, logically, or otherwise linked to another element/node/feature in a direct or indirect manner, unless explicitly stated otherwise to allow interaction, even if these two features may not be directly connected. That is, “couple” is intended to include both direct and indirect connection of elements or other features, and includes a connection with one or more intermediate elements.

In addition, the terms “first”, “second”, and the like may also be used herein for the purpose of reference only, and thus are not intended to be limiting. For example, the terms “first”, “second”, and other such numerical terms referring to the structure or element do not imply the sequence or order, unless specifically pointed out in the context.

It is also to be understood that the terms “comprise/include” herein means that the described features, steps, operations, units and/or components exist, but the existence or adding of one or more other features, steps, operations, units and/or components and/or combinations thereof are not excluded.

Those skilled in the art will appreciate that the boundaries between the above operations are merely illustrative. Multiple operations may be combined into a single operation, a single operation may be distributed among additional operations, and operations may be performed at least partially overlapping in time. Moreover, alternative embodiments may include multiple instances of a particular operation, and the operational sequence may be varied in other various embodiments. However, other modifications, changes, and substitutions are equally possible. Accordingly, the specification and drawings are to be regarded as illustrative rather than limiting.

While some specific embodiments of the present disclosure have been described in detail by way of example, a skilled person should be understood that the above examples are for illustrative purpose and have no intention to limit the scope of the present disclosure. The embodiments disclosed in the present disclosure may be combined in any manner without departing from the spirit and scope of the present disclosure. It will be understood by a person skilled in the art that various modifications may be made to the embodiments without departing from the scope and spirit of the present disclosure. The scope of the present disclosure is defined by the appended claims.

1. A base station antenna, comprising:
an array of radiating elements, including multiple columns of radiating elements with each column including multiple radiating elements;
a first phase shifter configured to impart a phase progression to sub-components of a radio frequency (RF) signal of a first frequency band for transmission in a beam forming mode;
a second phase shifter configured to impart a phase progression to sub-components of an RF signal of a second frequency band for transmission in a multi-beam mode, wherein the second frequency band is different from the first frequency band, the RF signal of the second frequency band includes a first beam signal and a second beam signal;
a multi-beam device configured to generate an output signal corresponding to the corresponding radiating elements according to the phase shifted first beam signal and the phase shifted second beam signal; and
a diplexer configured to receive the phase shifted RF signal of the first frequency band and the output signal of the multi-beam device, and transmit a diplexer output signal to the corresponding radiating elements.

2. The base station antenna of claim 1, wherein the second phase shifter comprises
a first beam phase shifter configured to change a phase of the first beam signal; and
a second beam phase shifter configured to change a phase of the second beam signal.

3. The base station antenna of claim 1, wherein a predetermined amount of radiating elements in each row are coupled to the same diplexer,
the base station antenna further comprises a power divider configured to distribute a power of the corresponding diplexer output signal to a predetermined amount of corresponding radiating elements according to a predetermined ratio.

4. The base station antenna of claim 3, wherein the predetermined amount is greater than or equal to 2 and less than or equal to 6.

5. The base station antenna of claim 1, wherein the multi-beam device is a Butler matrix.

6. The base station antenna of claim 5, wherein
the Butler matrix includes a first input port, a second input port and a plurality of first output ports, the first input port receives the phase shifted first beam signal, the second input port receives the phase shifted second beam signal, and the plurality of first output ports are respectively coupled to corresponding radiating elements through the plurality of diplexers.

7. The base station antenna of claim 6, wherein the array of radiating elements comprises a plurality of rows, and the plurality of output ports of each Butler matrix are coupled to corresponding radiating elements in the same row.

8. The base station antenna of claim 6, wherein,
the diplexer comprises a third input port, a fourth input port and a second output port, and
the third input port receives the phase shifted RF signal of the first frequency band, the fourth input port is coupled to the first output port of the Butler matrix, and the second output port is coupled to the corresponding radiating element.

9. The base station antenna of claim 1, wherein the first phase shifter comprises a plurality of third output ports which are respectively coupled to corresponding radiating elements in the same column.

10.-15. (canceled)

16. A base station antenna comprising:
a first sector-splitting port;
a second sector-splitting port;
a plurality of beam forming ports;
a multi-column array of radiating elements, with each column including multiple radiating elements;
a plurality of first phase shifters that are coupled between the respective beam forming ports and the columns of the array of radiating elements, the plurality of first phase shifters together having a plurality of first phase shifter outputs;
a second phase shifter having an input port that is coupled to the first sector-splitting port and a plurality of second phase shifter outputs;
a third phase shifter having an input port that is coupled to the second sector-splitting port and a plurality of third phase shifter outputs;
a plurality of multi-beam devices, each multi-beam device coupled to a respective one of the second phase shifter outputs and a respective one of the third phase shifter outputs, the plurality of multi-beam devices together having a plurality of multi-beam device outputs; and
a plurality of diplexers, each diplexer having a first input port that is coupled to a respective one of the first phase shifter outputs, a second input port that is coupled to a respective one of the multi-beam device outputs, and an output port that is coupled to a respective one of the radiating elements in the array of radiating elements.

17. The base station antenna of claim 16, wherein the multi-beam devices are Butler Matrices.

18. The base station antenna of claim 16, wherein two first phase shifters are coupled to the radiating elements in each column of the array of radiating elements for each polarization radiator of the radiating elements.

19. The base station antenna of claim 17, wherein the number of Butler Matrices that are connected to the multi-column array of radiating elements is equal to twice the number of columns in the multi-column array of radiating elements.

20. The base station antenna of claim 16, wherein a predetermined amount of radiating elements in each row are coupled to the same diplexer,
the base station antenna further comprises
a power divider configured to distribute a power of the signal output from the output port of the corresponding diplexer to a predetermined amount of corresponding radiating elements according to a predetermined ratio.

21. The base station antenna of claim 20, wherein the predetermined amount is greater than or equal to 2 and less than or equal to 6.

22. The base station antenna of claim 16, wherein the array of radiating elements comprises a plurality of rows, and the plurality of multi-beam device outputs of each multi-beam devices are coupled to corresponding radiating elements in the same row.

23. A base station antenna comprising:
a first sector-splitting port;
a second sector-splitting port;
a plurality of beam forming ports;
a multi-beam device having first and second inputs that are coupled to the respective first and second sector-splitting ports and a plurality of multi-beam device outputs;
a plurality of phase shifters, the plurality of phase shifters together having a plurality of phase shifter outputs;
a plurality of diplexers, each diplexer having a first input port that is coupled to a respective one of the beam forming ports, a second input port that is coupled to a respective one of the multi-beam device outputs, and an output port that is coupled to a respective one of the phase shifters;
a multi-column array of radiating elements, with each column including multiple radiating elements;
wherein each phase shifter output is coupled to a respective one of the radiating elements in the array of radiating elements.

24. The base station antenna of claim 23, wherein the multi-beam device is a Butler Matrix.

25. The base station antenna of claim 23, wherein the array of radiating elements comprises a plurality of rows, and the plurality of multi-beam device outputs of each multi-beam devices are coupled to corresponding radiating elements in the same row of the array of radiating elements.

26. The base station antenna of claim 23, wherein each of the phase shifters includes a plurality of phase shifter outputs, and the plurality of the phase shifter outputs of each phase shifter are respectively coupled to the corresponding radiating elements in the same column of the array of radiating elements.

27. (canceled)
